(19) United States
(12) Patent Application Publication
(10) Pub. No.: US 2015/0180840 A1
(43) Pub. Date: Jun. 25, 2015

(54) FIRMWARE UPGRADE METHOD AND SYSTEM THEREOF

(71) Applicant: HYUNDAI MOTOR COMPANY, Seoul (KR)

(72) Inventors: Ho Jin JUNG, Seoul (KR); Hyun Soo Ahn, Seoul (KR); Chung Hi Lee, Seoul (KR)

(73) Assignee: HYUNDAI MOTOR COMPANY

(21) Appl. No.: 14/553,645

(22) Filed: Nov. 25, 2014

(30) Foreign Application Priority Data
Dec. 24, 2013 (KR) 10-2013-0162187

(51) Int. Cl. H04L 29/06; G06F 9/445; H04L 9/08

(52) U.S. Cl. CPC H04L 63/0435; H04L 9/0861; H04L 9/0869; G06F 8/65

(57) ABSTRACT

A firmware transmission method through which a server transmits firmware, includes generating a secret key using a designated secret key generation function, encrypting original firmware using the secret key, encrypting the secret key using a public key of a reception terminal which is stored in advance, and generating a hash value by inputting the original firmware to a designated hash function, and encrypting the generated hash value using a private key of the server which is stored in advance, wherein firmware data including the encrypted original firmware, the encrypted secret key, and the encrypted hash value is transmitted to the reception terminal. Therefore, the firmware transmission method provides safe firmware upgrade.

### CROSS-REFERENCE TO RELATED APPLICATION

This application claims the benefit of Korean Patent Application No. 10-2013-0162187, filed on Dec. 24, 2013, which is hereby incorporated by reference as if fully set forth herein.

### TECHNICAL FIELD

The present disclosure relates to a firmware upgrade method and a system thereof, and more particularly, to an encryption/decryption method based on a plurality of solutions to provide safe upgrade of firmware and an apparatus and system supporting the same.

### BACKGROUND

In general, vehicles, for example, including automobiles, trucks, buses, agricultural vehicles, and airplanes, include a vehicle communication system. Complexity of the vehicle communication system rapidly increases according to increase in kinds and the number of electric devices in a vehicle. For example, more improved vehicles include engine control, transmission control, antilock braking, body control, emission control, automatic indoor climate control, automatic illumination control, automatic mirror control, etc.

Further, in order to support various electrical devices in vehicles, numerous communication protocols in the automobile industry are generated.

According to development of automobile technologies, more various and complex measuring and sensing functions are provided to recently launched vehicles. These sensing functions may be provided by an electronic control unit (ECU) of a vehicle.

Further, a standardized interface, i.e., an on board diagnostics (OBD) connector, to which a vehicle self diagnostic apparatus, i.e., an OBD apparatus (hereinafter, referred to as a “diagnostic apparatus”) may be connected to the vehicle. When the OBD apparatus is connected to the vehicle, information measured and sensed by various ECUs according to designated control procedures, for example, vehicle information, a driving record, exhaust gas information, error information, etc., are transmitted to the OBD apparatus.

Further, the diagnostic apparatus may receive firmware to drive an ECU through interlocking with a designated server and install the received firmware on the corresponding ECU through a designated control procedure.

Particularly, a larger number of ECUs is mounted in the vehicle according to advancement of vehicles and continuous requirements of consumer safety and convenience and thus, frequent ECU firmware upgrade is required. Therefore, a method for allowing a server to safely transmit firmware to a corresponding ECU through a diagnostic apparatus has been required.

FIG. 1 illustrates a conventional firmware upgrade process performed by a server, a diagnostic apparatus and an ECU.

As exemplarily shown in FIG. 1, a simple seed-key algorithm is applied to the conventional firmware upgrade process, and thus only an authentication procedure between the diagnostic apparatus and the ECU is performed.

With reference to FIG. 1, the diagnostic apparatus requests the server to transmit new firmware, and the server transmits new firmware data to the diagnostic apparatus. Thereafter, the diagnostic apparatus requests the ECU to perform re-programming, and in response the corresponding ECU generates a random number, i.e., a seed value, stores the seed value, and then transmits the seed value to the diagnostic apparatus. The diagnostic apparatus generates a key value using the received seed value and a key generation function, which is known in advance, and transmits the generated key value to the ECU. The ECU generates a key value using a seed value, which is stored in advance, and a key generation function, which is known in advance, and judges whether or not the generated key value and the key value received from the diagnostic apparatus coincide with each other through comparison. As a result of comparison, upon judging that the generated key value and the received key value coincide with each other, the ECU judges that the external diagnostic apparatus is authenticated and receives firmware data transmitted from the diagnostic apparatus through a designated control procedure. When transmission of the firmware data has been completed, the ECU performs re-programming using the received firmware data.

However, the above-described method does not guarantee confidentiality and integrity, which are important factors in safety, and is weak to hacker attack.

### SUMMARY

Accordingly, the present disclosure is directed to a firmware upgrade method and a system thereof that substantially obviate one or more problems due to limitations and disadvantages of the related art.

An object of the present disclosure is to provide a safe firmware encryption and decryption method for vehicles.

Another object of the present inventive concept is to provide a firmware encryption method for vehicles that guarantees confidentiality and integrity, and may thus achieve safe firmware transmission and upgrade.

Another object of the present inventive concept is to provide a firmware encryption method for vehicles, which is highly resistant to hacking and thereby guarantees driver safety.

Yet another object of the present inventive concept is to provide a safe firmware encryption method for vehicles based on plural solutions, which may achieve safe firmware upgrade.

Additional advantages, objects, and features of the inventive concept will be set forth in part in the description that follows and in part will become apparent to those having ordinary skill in the art upon examination of the following or may be learned from practice of the disclosure. The objectives and other advantages of the inventive concept may be realized and attained by the structure particularly pointed out in the written description and claims hereof as well as the appended drawings.

To achieve these objects and other advantages and in accordance with the purpose of the disclosure, as embodied and broadly described herein, a firmware transmission method through which a server transmits firmware includes generating a secret key using a designated secret key generation function, encrypting original firmware using the secret key, encrypting the secret key using a public key of a reception terminal that is stored in advance, and generating a hash value by inputting the original firmware to a designated hash function, and encrypting the generated hash value using a private key of the server that is stored in advance, wherein firmware data including the encrypted original firmware, the encrypted secret key, and the encrypted hash value is transmitted to the reception terminal.

The secret key may be generated by inputting current time information to the secret key generation function.

The reception terminal may be an electronic control unit (ECU) in a vehicle.

The firmware data may further include an ECU identifier to inherently identify the reception terminal.

The firmware data may be transmitted to the reception terminal via a diagnostic apparatus and a gateway for vehicles.

In another aspect of the present inventive concept, a firmware data processing method through which an electronic control unit (ECU) for vehicles processes firmware data transmitted by a server includes receiving the firmware data including encrypted firmware, an encrypted secret key, and an encrypted hash value, decrypting the encrypted secret key using a private key of the ECU that is stored in advance, decrypting the encrypted firmware using the decrypted secret key, acquiring a first hash value by inputting the decrypted firmware to a designated hash function, decrypting the encrypted hash value using a public key of the server which is stored in advance, and judging whether or not the first hash value and the decrypted hash value are the same, wherein, upon judging that the first hash value and the decrypted hash value are the same, designated re-programming is performed using the decrypted firmware.

The encrypted firmware may be information acquired by encrypting the decrypted firmware using the decrypted secret key.

The encrypted secret key may be information encrypted using a public key of the ECU.

The encrypted hash value may be information encrypted using a private key of the server.

The decrypted secret key may be generated by the server and is generated by inputting current time information as a seed value to a designated secret key generation function.

In another aspect of the present inventive concept, a server providing firmware includes a controller, a firmware database in which original firmware is stored, a secret key generation module generating a secret key using a designated secret key generation function, a firmware encryption module encrypting the original firmware using the secret key, a secret key encryption module encrypting the secret key using a reception terminal public key that is stored in advance, a hash value encryption module generating a hash value by inputting the original firmware to a designated hash function and encrypting the generated hash value using a private key of the server, and a communication unit transmitting firmware data including the encrypted firmware, the encrypted secret key, and the encrypted hash value to an external device according to a control signal from the controller.

In another aspect of the present inventive concept, an electronic control unit (ECU) performing firmware upgrade by interlocking with a server includes a controller, a communication unit receiving firmware data including encrypted firmware, an encrypted secret key, and an encrypted hash value and providing the received firmware data to the controller, a secret key decryption module decrypting the encrypted secret key using a private key of the ECU that is stored in advance, a firmware decryption module decrypting the encrypted firmware using the decrypted secret key, and an integrity check module acquiring a first hash value by inputting the decrypted firmware to a designated hash function, decrypting the encrypted hash value using a public key of the server that is stored in advance, and judging that the decrypted firmware is integral if the first hash value and the decrypted hash value are the same, wherein, upon judging that the decrypted firmware is integral, re-programming is performed using the decrypted firmware.

In yet another aspect of the present inventive concept, a system providing firmware upgrade includes a diagnostic apparatus, a server transmitting firmware data including encrypted firmware, an encrypted secret key, and an encrypted hash value to the diagnostic apparatus according to a firmware transmission request from the diagnostic apparatus, and an electronic control unit (ECU), when the ECU receives the firmware data, decrypting the encrypted secret key using a private key of the ECU, decrypting the encrypted firmware using the decrypted secret key, and performing re-programming using the decrypted firmware if a first hash value acquired by inputting the decrypted firmware to a designated hash function and a second hash value acquired by decrypting the encrypted hash value using a public key of the server which is stored in advance are the same.

It is to be understood that both the foregoing general description and the following detailed description of the present disclosure are exemplary and explanatory and are intended to provide further explanation of the disclosure as claimed.

### BRIEF DESCRIPTION OF THE DRAWINGS

The accompanying drawings, which are included to provide a further understanding of the invention and are incorporated in and constitute a part of this application, illustrate embodiment(s) of the inventive concept and together with the description serve to explain the principle of the disclosure. In the drawings:

FIG. 1 is a flowchart illustrating a conventional vehicle firmware re-programming procedure;

FIG. 2 is a block diagram illustrating a vehicle communication network in accordance with one embodiment of the present inventive concept;

FIG. 3 is a block diagram illustrating a system to which a vehicle firmware encryption method in accordance with one embodiment of the present inventive concept is applied;

FIG. 4 is a block diagram illustrating activities of components of the system of FIG. 3 for performing a firmware encryption procedure in a server in accordance with one embodiment of the present inventive concept;

FIG. 5 is a block diagram illustrating activities of components of the system of FIG. 3 for performing a decryption procedure in an ECU in accordance with one embodiment of the present inventive concept;

FIG. 6 is a flowchart illustrating a firmware encryption procedure in the server in accordance with one embodiment of the present inventive concept;

FIG. 7 is a flowchart illustrating an encryption data transmission procedure in a diagnostic apparatus in accordance with one embodiment of the present inventive concept;

FIG. 8 is a flowchart illustrating a firmware decryption procedure in the ECU in accordance with one embodiment of the present inventive concept;

FIG. 9 is a block diagram illustrating the inner configuration of the server in accordance with one embodiment of the present inventive concept; and

FIG. 10 is a block diagram illustrating the inner configuration of the ECU in accordance with one embodiment of the present inventive concept.

### DETAILED DESCRIPTION OF THE DRAWINGS

Reference will now be made in detail to the preferred embodiments of the present disclosure, examples of which are illustrated in the accompanying drawings. The suffixes “module” and “unit” in elements used in description below are given or used together in consideration of only ease in preparation of the specification and do not have distinctive meanings or functions.

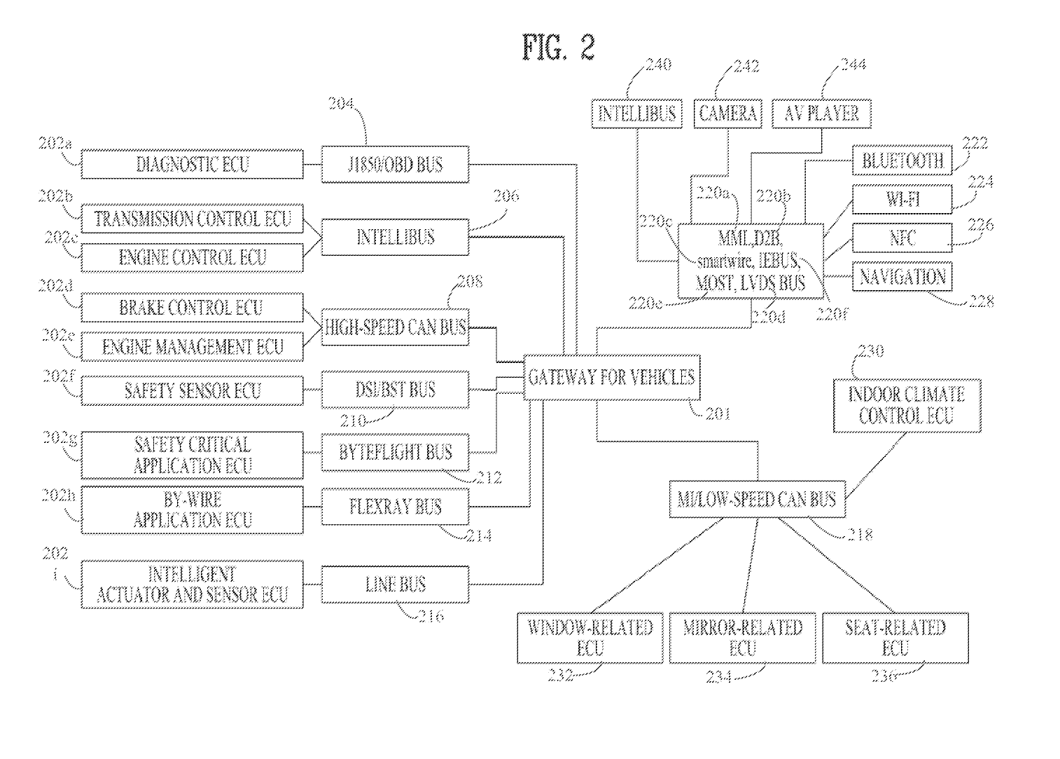

FIG. 2 is a block diagram illustrating a vehicle communication network in accordance with one embodiment of the present inventive concept.

As exemplarily shown in FIG. 2, a vehicle communication network in accordance with the present disclosure provides protocol conversion between electronic control units (ECUs) supporting different bus communication protocols in one gateway for vehicles and may thus achieve communication between the ECUs.

Hereinafter, bus communication protocols that may be connected to the gateway for vehicles and ECUs using the corresponding bus communication protocols will be described in brief. For example, the bus communication protocols may include:

(1) J1850 and/or OBDII buses 204 generally used for vehicle diagnostic electrical elements;

(2) an IntelliBus 206 that is generally used for other vehicle systems, such as engine control, transmission control, and indoor climate control, and may be used for a drive-by-wire electronic control unit (ECU);

(3) a high-speed measurement controller area network (CAN) bus 208 generally used for braking systems and engine management systems;

(4) distributed system interface (DSI) and/or Bosch-Siemens-Temic (BST) buses 210 generally used in safety-related electrical devices;

(5) a Byteflight bus 212 generally used for electrical device applications important to safety;

(6) a local interconnect network (LIN) bus 216 generally used for intelligent actuators and/or intelligent sensors;

(7) low-speed measurement CAN and/or Motorola interconnect (MI) buses 218 generally used for windows, mirrors, seats, and/or low-speed electrical devices, such as an indoor climate adjustor;

(8) a mobile media link (MML) bus 220a, a domestic digital data (D2B) bus 220b, a smartwireX bus 220c, an inter-equipment bus (IEBus) 220d, and/or a media oriented system transport (MOST) bus 220 generally used to support multi-media electrical devices in a vehicle, such as an audio head unit, an amplifier, a CD player, a DVD player, a cellular connection, a Bluetooth connection, peripheral computer connections, rear seat entertainment units, a radio, a digital storage, and/or an GPS navigation system;

(9) a low-voltage differential signaling (LVDS) 220f bus generally used to support head up displays, instrument panel displays, other digital displays, and driver assistant digital video cameras;

(10) a FlexRay bus 214 used for characteristics important to safety and/or by-wire applications; and

(11) Ethernet used for interlocking with an on-board diagnostic (OBD) system having high efficiency of an available bandwidth through one-to-one communication connection with a device, an infotainment system, and a driver assistant system (DAS) including a surround view function using a camera.

In order to achieve communication between ECUs or electronic components using different bus communication protocols in the above-described example, one or more gateway for vehicles 201 may be included in a vehicle network. For example, in terms of a safety-related issue, a braking ECU 202d, an engine control ECU 202c, and/or a transmission control ECU 202b need to communicate with each other. Here, the gateway needs to provide a protocol conversion function to facilitate communication between the ECUs supporting the different communication protocols.

A gateway for vehicles in accordance with one embodiment the present inventive concept may include a designated diagnostic communication interface module and communicate with an external diagnostic apparatus through the diagnostic communication interface module. Here, the diagnostic communication interface module may provide at least one of an Ethernet communication function, a Bluetooth communication function 222, an Wi-Fi communication function 224, a near-field communication (NFC) function 226, a wideband code division multiple access (WCDMA) communication function, a long term evolution (LTE) communication function, and an LTE-advanced communication function.

Further, a gateway for vehicles in accordance with another embodiment the present inventive concept may further include a designated connection control module to authenticate, for example, if an external diagnostic apparatus requests connection to the gateway for vehicles of an OBD terminal or a specific ECU, connection authority of the corresponding external diagnostic apparatus to the corresponding gateway for vehicles or the corresponding ECU. Here, the connection control module may include a unit for generating a random number (a seed value) according to a connection request from the external diagnostic apparatus, transmitting the random number to the external diagnostic apparatus, and storing the random number, a unit for receiving a key value, generated using the transmitted seed value, from the external diagnostic apparatus, a unit for judging whether or not the received key value is the same as a key value generated by inputting the stored seed value to a designated key generation function, and a unit for transmitting a designated control signal indicating success of authentication to the external diagnostic apparatus upon judging that the received key value is the same as the generated key value.

In accordance with yet another embodiment of the present inventive concept, each ECU may have various functions performed by the above-described connection control module. That is, each ECU may perform a designated procedure to authenticate connection authority when a connection request is received from an external diagnostic apparatus.

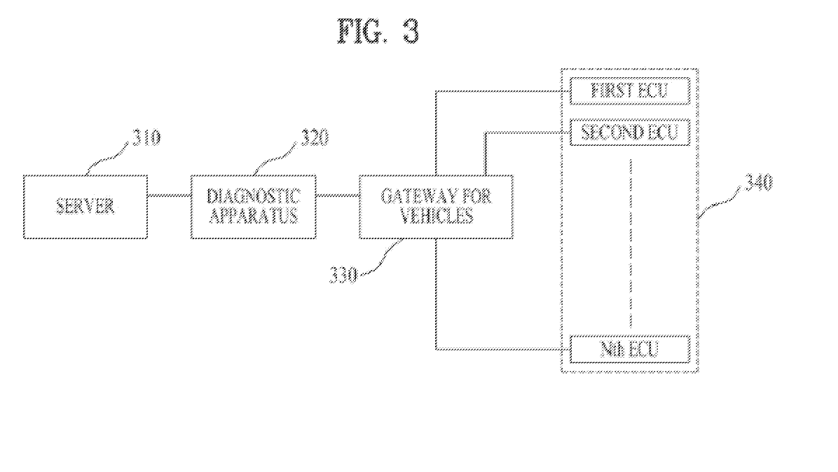

FIG. 3 is a block diagram illustrating a system to which a vehicle firmware encryption method in accordance with one embodiment of the present inventive concept is applied.

With reference to FIG. 3, a system in accordance with the present disclosure may include a server 310, a diagnostic apparatus 320, a gateway 330 for vehicles, and first to N^{th} ECUs 340.

The server 310 may perform communication with the diagnostic apparatus 320 through wired or wireless connection, and when the server 310 receives a firmware transmission request of a specific ECU from the diagnostic apparatus 320, the server 310 is configured to encrypt the corresponding firmware and provide the encrypted firmware to the diagnostic apparatus 320. A firmware encryption procedure performed by the server 310 will be more apparent through description below with reference to the drawings.

The diagnostic apparatus 320 performs a function of transmitting the encrypted firmware received from the server 310 to the corresponding ECU through the gateway 330 for vehicles.

A description of the gateway 330 for vehicles is the same as the above description with reference to FIG. 2 and will thus be omitted.

The first to N^{th} ECUs 340 may perform re-programming by decrypting the encrypted firmware received from the diagnostic apparatus 320. Further, the first to N^{th} ECUs 340 may start a designated authentication procedure to confirm whether or not the corresponding diagnostic apparatus 320 has connection authority according to a re-programming request from the diagnostic apparatus 320.

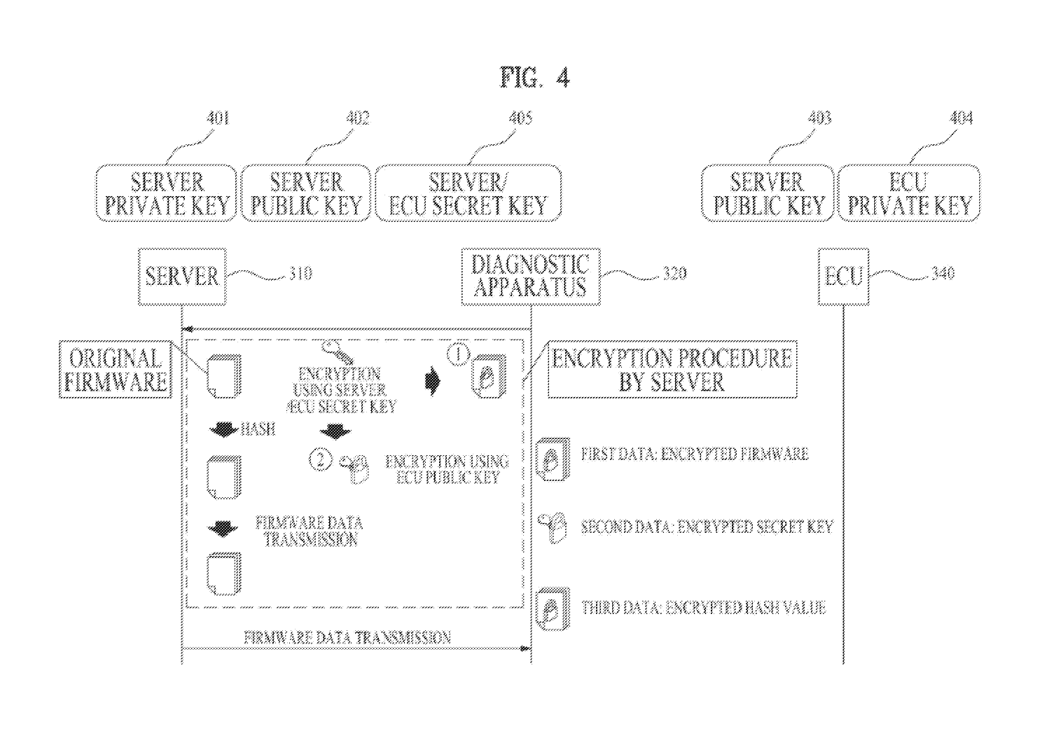

FIG. 4 is a block diagram illustrating activities of components of the system of FIG. 3 for performing a firmware encryption procedure in a server in accordance with one embodiment of the present inventive concept.

With reference to FIG. 4, the server 310 may maintain a server private key 401 and an ECU public key 402 in a designated recording area in advance. Further, the server 310 may maintain a server public key 403 and an ECU private key 404 in a designated recording area in advance.

The server private key 401 is a security key maintained in the corresponding server 310 and is not possessed jointly by other devices except for the corresponding server 310. On the other hand, the server public key 403 is a security key possessed jointly by other devices except for the corresponding server 310 and may be a security key known to all ECUs. The server private key 401 and the server public key 403 pair off exclusively and are not related to other different security keys. Therefore, data encrypted by the server private key 401 may be decrypted only by the server public key 403, and vice versa. That is, in a private key/public key structure, an encryption/decryption operation is performed in one direction. Therefore, the server 310 may not decrypt data, encrypted by the server private key 401, using the server private key 401. Further, an algorithm used in the private key/public key structure is designed such that one key of one pair of keys may not be discriminated using the other key. Therefore, the private key may not be decrypted through the public key, and the public key may not be decrypted through the private key.

The ECU private key 404 is a security key maintained in the corresponding ECU and is not possessed jointly by other devices except for the corresponding ECU. On the other hand, the ECU public key 402 is a security key possessed jointly by other devices except for the corresponding ECU 340, for example, the server 310.

A server/ECU secret key 405 is a security key generated by the corresponding server 310, and the ECU 340 may not directly know the server/ECU secret key 405. However, the ECU 340 may acquire the server/ECU secret key 405 generated by the server 310 by receiving the encrypted server/ECU secret key 405 using the ECU public key 402 and decrypting the encrypted server/ECU secret key 405 using the ECU private key 404.

The server/ECU secret key 405 in accordance with one embodiment of the present inventive concept may be acquired by inputting current time information at the time of secret key generation as a seed value to a secret key generation function of a designated order. Therefore, the server/ECU secret key 405 may not be decrypted if accurate time information when the server/ECU secret key 405 is generated is not known although a reception terminal or a specific device on a communication path knows the secret key generation function.

Hereinafter, with reference to FIG. 4, a firmware decryption procedure in the server 310 in accordance with the present disclosure will be described in detail.

The server 310 may receive a designated firmware transmission request message from the diagnostic apparatus 320. Here, the firmware transmission request message may include at least one of a designated ECU identifier indicating to which ECU the firmware transmission request corresponds and version information of firmware installed in the corresponding ECU. In this case, the server 310 is configured to confirm whether or not newly changed firmware corresponding to the received ECU identifier is present and, if newly changed firmware is present, start an encryption procedure. In accordance with another embodiment of the present inventive concept, when the server 310 receives a firmware transmission request message, the server 310 is configured to confirm whether or not newly changed firmware of ECUs mounted in a corresponding vehicle is present and start an encryption procedure of at least one firmware according to a result of confirmation.

When firmware which is a target for encryption is identified, the server 310 encrypts the identified original firmware using the server/ECU secret key 405. Hereinafter, original data encrypted by the server/ECU secret key 405 will be referred to as “first data”, for convenience of description.

The server 310 encrypts the server/ECU secret key 405 using the ECU public key 402. Hereinafter, the server/ECU secret key 405 encrypted using the ECU public key 402 will be referred to as “second data”, for convenience of description.

The server 310 is configured to guarantee confidentiality of the original firmware through the above-described generation of the first data and the second data.

Thereafter, the server 310 generates a hash value by using the original firmware as an input value of a designated hash function which is known in advance and encrypts the generated hash value using the server private key 401. Hereinafter, the hash value encrypted using the server private key 401 will be referred to as “third data”, for convenience of description.

The server 310 is configured to provide integrity of the original firmware and an authentication unit to the server 310 in the ECU through generation of the third data.

The server 310 transmits firmware data including the first data, the second data, and the third data to the diagnostic apparatus 320 through a designated communication channel.

Hereinafter, for better understanding of the present disclosure, a hash function and a hash value will be described in brief.

In general, a hash function or hash method is a kind of computer encryption technique and may be referred to as an abstract function or a message digest function. The hash function is a computation method of generating a pseudo random number of a fixed length in a given original text, and a value generated thereby will be referred to as a hash value. The hash function, when data is exchanged through a communication line, is configured to confirm whether or not any change is applied to the original text by calculating hash values of the original text at both terminals of a path and then comparing the hash values of both transmission and reception terminals.

Particularly, the hash function includes an irreversible one-way function and may thus not reproduce the original text from the hash value. Further, it is very difficult to prepare another original text having the same hash value. Based on such characteristics, the hash function may be applied to an encryption assistance unit in communication, user authentication, digital signature, etc. Here, the one-way function may be referred to as a trap door function. That is, the one-way function is a function in which acquisition of a result from a divisor is simple but acquisition of a divisor from a result is difficult.

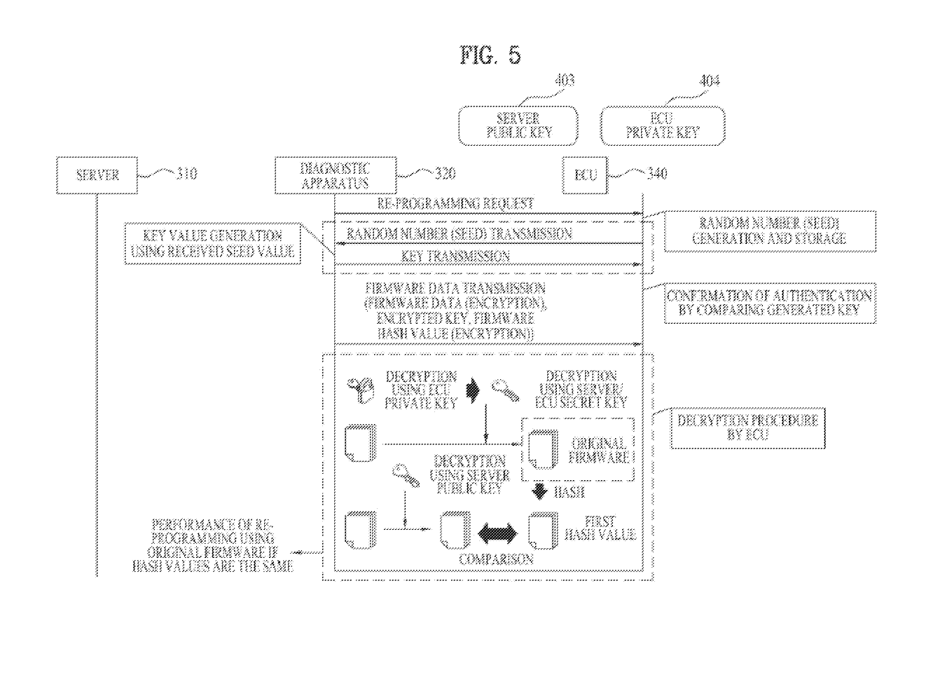

FIG. 5 is a block diagram illustrating activities of components of the system of FIG. 3 for performing a decryption procedure in the ECU in accordance with one embodiment of the present inventive concept.

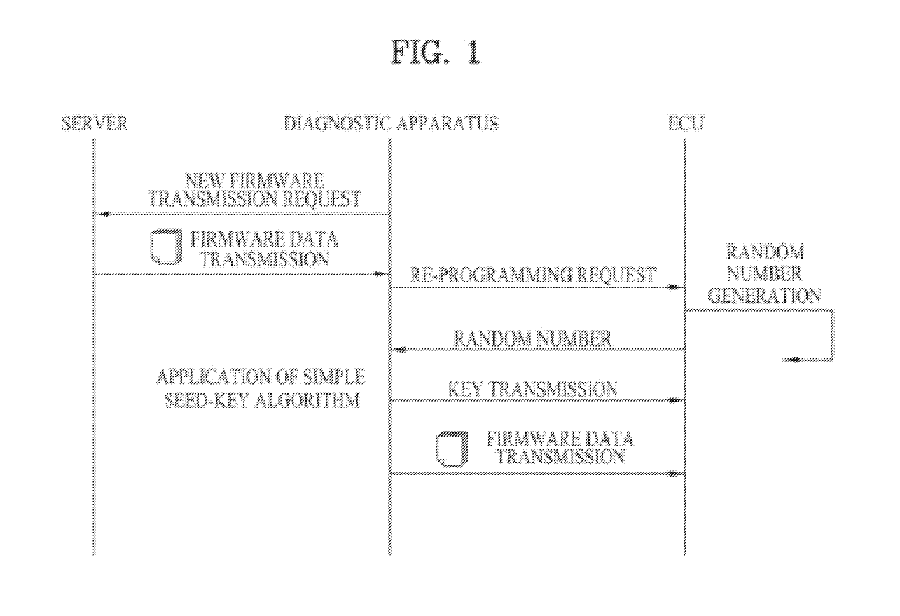

With reference to FIG. 5, when the ECU 340 receives a designated re-programming request message from the diagnostic apparatus 320, the ECU 340 starts a designated authentication procedure. A description of the authentication procedure is the same as the above description with reference to FIG. 1 and will thus be omitted.

When the ECU 340 succeeds in authentication, the ECU 340 receives firmware data including the first data, the second data, and the third data from the diagnostic apparatus 320.

Hereinafter, the ECU 340 may acquire the server/ECU secret key 405 by decrypting the second data using the ECU private key 404 and acquire the original firmware by decrypting the first data using the acquired server/ECU secret key 405.

Then, the ECU 340 may acquire a hash value by inputting the acquired original firmware to a designated hash function. Hereinafter, the acquired hash value will be referred to as “a first hash value”, for convenience of description.

Further, the ECU 340 may acquire a hash value generated by the server 310 by decrypting the third data using the server public key 403. Hereinafter, the hash value decrypted using the server public key 403 will be referred to as “a second hash value”, for convenience of description.

Thereafter, the ECU 340 confirms whether or not the first hash value and the second hash value are the same.

As a result of confirmation, if the two hash values are the same, the ECU 340 starts a designated re-programming procedure using the decrypted original firmware. If the two hash values are not the same, the ECU 340 is configured to transmit a designated message indicating that re-programming is impossible to the diagnostic apparatus 320.

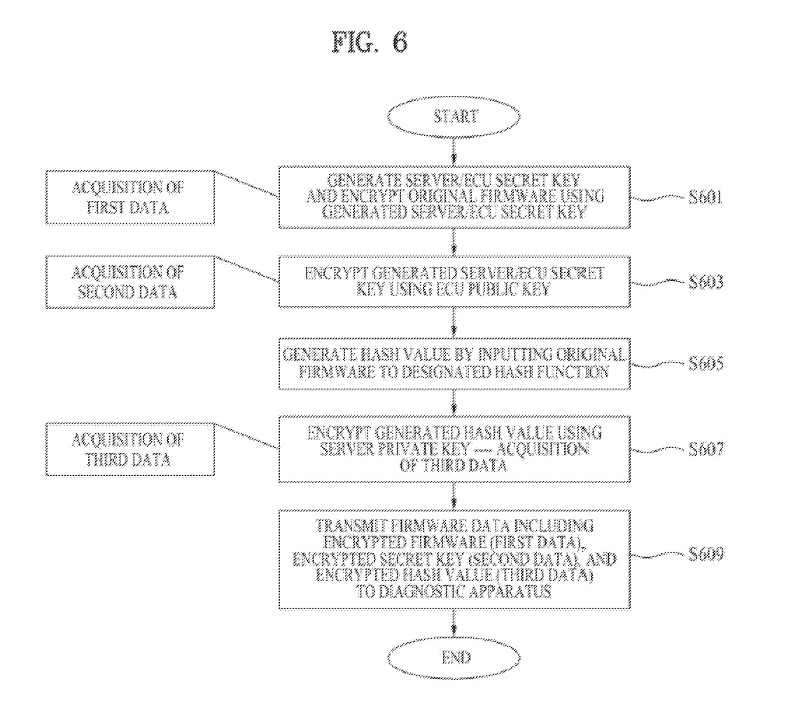

FIG. 6 is a flowchart illustrating a firmware encryption procedure in the server in accordance with one embodiment of the present inventive concept.

With reference to FIG. 6, the server 310 generates the server/ECU secret key 405 using a designated secret key generation function and acquires the first data by encrypting the original firmware using the generated server/ECU secret key 405 (at Step 601).

The server 310 acquires the second data by encrypting the generated server/ECU secret key 405 using the ECU public key 402 (at Step 603).

The server 310 generates a hash value by inputting the original firmware to a designated hash function (at Step 605) and acquires the third data by encrypting the generated hash value using the server private key 401 (at Step 607).

Thereafter, the server 310 transmits firmware data including the encrypted original firmware (first data), the encrypted server/ECU secret key (second data), and the encrypted hash value (third data) to the diagnostic apparatus 320 (at Step 609). Here, the server 310 may transmit firmware data further including a designated ECU identifier to the diagnostic apparatus 320 so as to identify an ECU which will receive the firmware data. Therefore, the diagnostic apparatus 320 is configured to transmit the corresponding firmware data to the ECU corresponding to the ECU identifier.

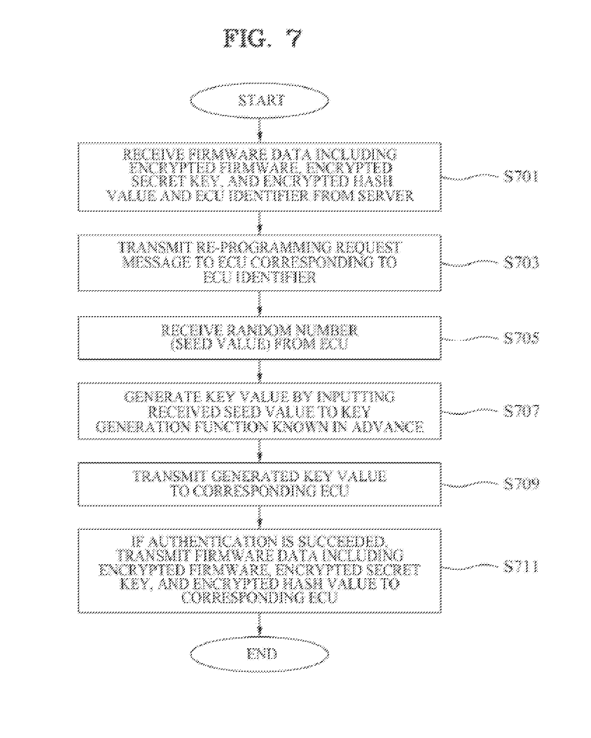

FIG. 7 is a flowchart illustrating an encryption data transmission procedure in the diagnostic apparatus in accordance with one embodiment of the present inventive concept.

In more detail, FIG. 7 is a flowchart illustrating a process of transmitting firmware data received from the server 310 by the diagnostic apparatus 320 to the ECU 340 through a designated re-programming procedure.

With reference to FIG. 7, when the diagnostic apparatus 320 receives the firmware data including the encrypted original firmware (first data), the encrypted server/ECU secret key (second data), the encrypted hash value (third data), and the ECU identifier from the server 310, the diagnostic apparatus 320 may transmit a designated re-programming request message to an ECU corresponding to the ECU identifier (at Step 701 and Step 703).

Thereafter, when the diagnostic apparatus 320 receives a random number (seed value) from the corresponding ECU (at Step 705), the diagnostic apparatus 320 generates a key value by inputting the received seed value to a key generation function which is known in advance (at Step 707), and transmits the generated key value to the corresponding ECU (at Step 709).

If authentication by the corresponding ECU is succeeded, the diagnostic apparatus 320 transmits the firmware data received in Operation 5710 to the corresponding ECU (at Step 711).

In the above-described embodiment, it is understood that all information transmitted and received between the diagnostic apparatus 320 and the corresponding ECU may be transmitted and received via the gateway 330 for vehicles. The gateway 330 for vehicles may perform routing by identifying a destination ECU through the above-described ECU identifier.

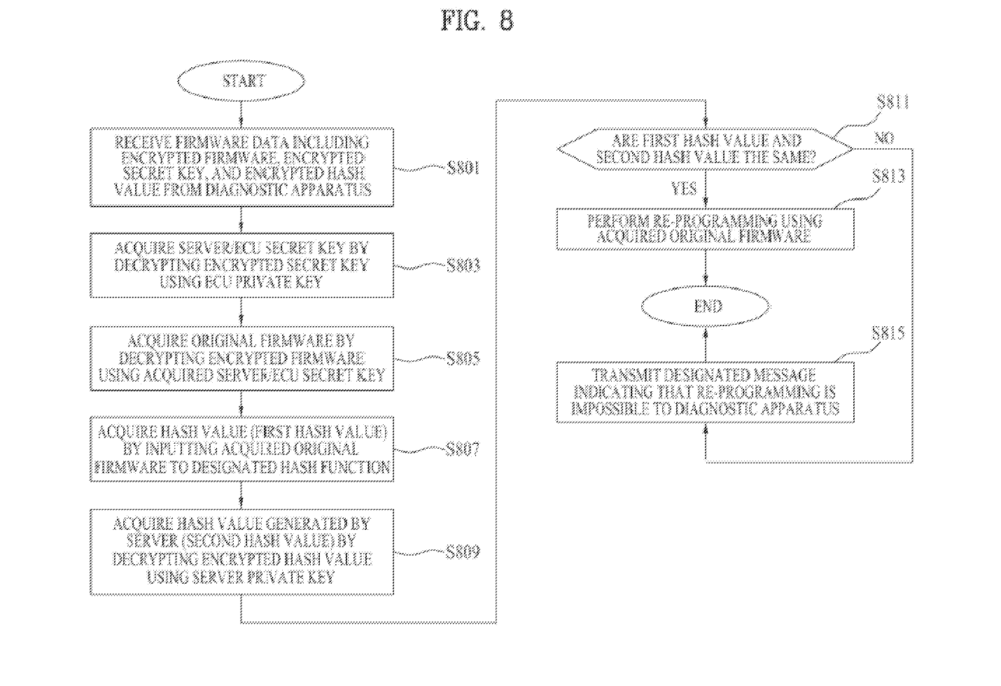

FIG. 8 is a flowchart illustrating a firmware decryption procedure in the ECU in accordance with one embodiment of the present inventive concept.

With reference to FIG. 8, the ECU 340 receives the firmware data including the encrypted original firmware (first data), the encrypted server/ECU secret key (second data), and the encrypted hash value (third data) from the diagnostic apparatus 320 (at Step 801).

The ECU 340 is configured to acquire the server/ECU secret key 405 by decrypting the second data using the ECU private key 404 (at Step 803). Next, the ECU 340 is configured to acquire the original firmware by decrypting the first data using the acquired server/ECU secret key 405 (at Step 805).

Thereafter, the ECU 340 is configured to acquire a hash value (first hash value) by inputting the acquired original firmware to the designated hash function that is known in advance (at Step 807). Next, the ECU 340 is configured to acquire a hash value (second hash value) generated by the server 310 by decrypting the third data using the server public key 403 (at Step 809).

The ECU 340 judges whether or not the first hash value and the second hash value are the same (at Step 811).

As a result of judgment, at Step 813, if the two hash values are the same, the ECU 340 starts a re-programming procedure using the original firmware acquired previously in Step 805.

On the other hand, if the two hash values are not the same, the ECU 340 is configured to generate a designated message indicating that re-programming is impossible and transmit the message to the diagnostic apparatus 320 (at Step 815).

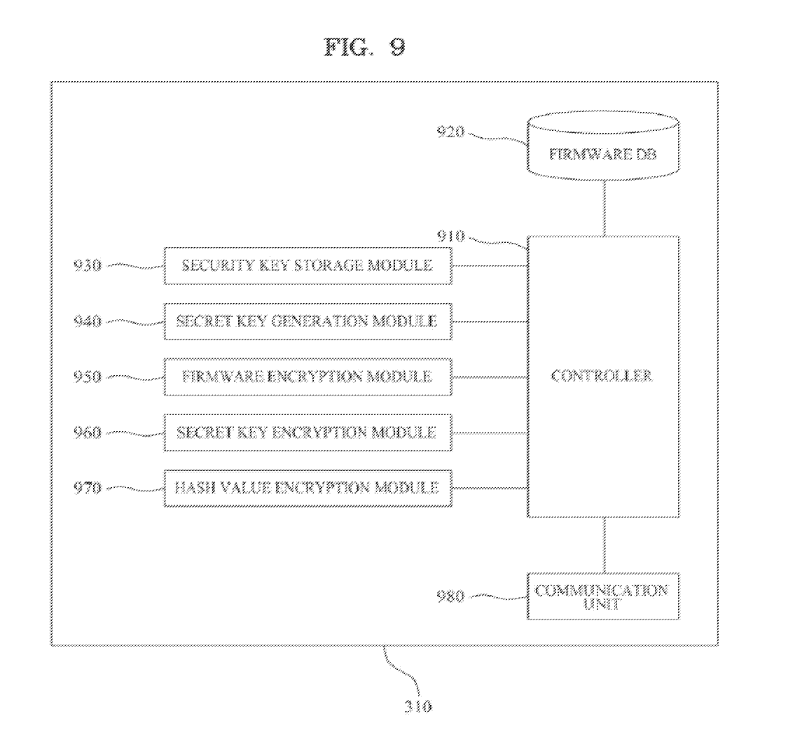

FIG. 9 is a block diagram illustrating the inner configuration of the server in accordance with one embodiment of the present inventive concept.

As exemplarily shown in FIG. 9, the server 310 may include a controller 910 and lower-level modules, such as a firmware database 920, a security key storage module 930, a secret key generation module 940, a firmware encryption module 950, a secret key encryption module 960, a hash value encryption module 970, and a communication unit 980.

The controller 910 may control operation of the lower-level modules and control message input/output to the inside or outside of the server 310.

The firmware database 920 is a storage medium to store original unencrypted firmware for ECUs mounted in a vehicle, and may maintain newest updated firmware information of the ECUs. Here, the ECUs mounted in the vehicle may be discriminated from one another in the server 310 through designated ECU identifiers to inherently identify the respective ECUs.

The security key storage module 930 is a storage medium to store security keys maintained in the server 310. The security key storage module 930 may be set such that only a user authenticated through a designated user authentication procedure may approach the security key storage module 930. For this purpose, the server 310 in accordance with one embodiment of the present inventive concept is configured to provide a designated login procedure.

The security key storage module 930 may store the server private key 401 and the ECU public key 402 of each of the ECUs mounted in the vehicle.

The secret key generation module 940 provides a function of generating the server/ECU secret key 405 using a designated secret key generation function. In accordance with one embodiment of the present inventive concept, the secret key generation module 940 is configured to generate the server/ECU secret key 405 by using current time information as a seed value of the secret key generation function. In accordance with another embodiment of the present inventive concept, the secret key generation module 940 is configured to generate the server/ECU secret key 405 by using an ECU identifier as a seed value of the secret key generation function.

The firmware encryption module 950 provides a function of generating encrypted firmware by encrypting the original firmware using the server/ECU secret key 405 generated by the secret key generation module 940.

The secret key encryption module 960 provides a function of generating a secret key by encrypting the server/ECU secret key 405 generated by the secret key generation module 940 using the ECU public key 402.

The hash value encryption module 970 provides a function of acquiring an encrypted hash value by inputting the original firmware to a designated hash key generation function and encrypting the acquired hash value using the server private key 401.

The controller 910 is configured to form firmware data including the encrypted firmware, the encrypted server/ECU secret key 405, and the encrypted hash value, and transmit a designated message including the formed firmware data to the diagnostic apparatus 320 through the communication unit 980. Here, the firmware data of the controller 910 may further include an ECU identifier to identify an ECU, which will receive the corresponding firmware data.

The communication unit 980 performs message or signal transmission between the server 310 and the diagnostic apparatus 320. The communication unit 980 in accordance with one embodiment of the present inventive concept is configured to provide at least one of a wireless or wireless Ethernet communication function, a Bluetooth communication function, a Wi-Fi communication function, a near-field communication (NFC) function, a wideband code division multiple access (WCDMA) communication function, a long term evolution (LTE) communication function, and an LTE-advanced communication function.

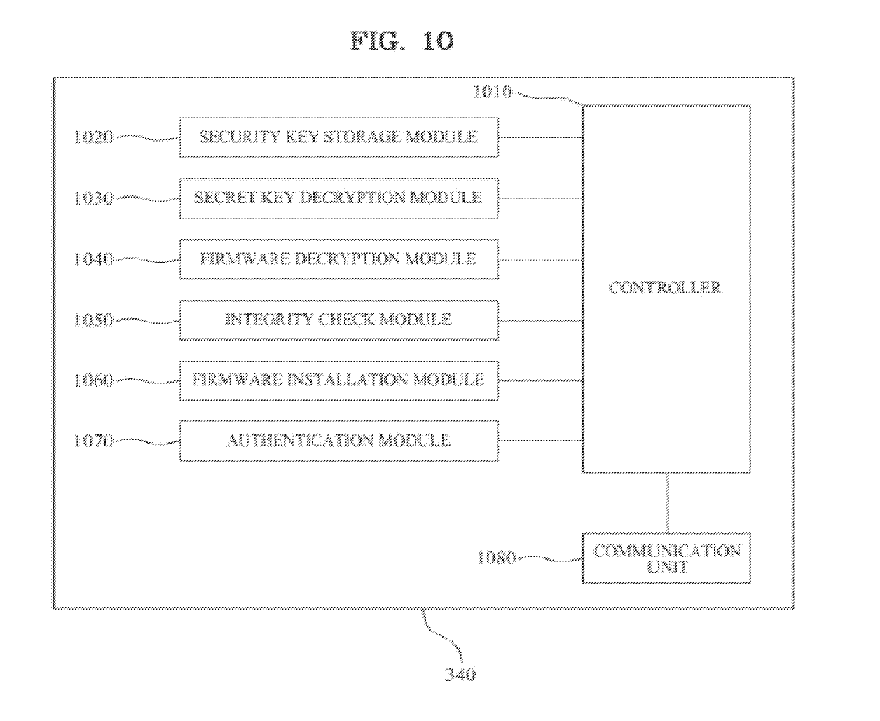

FIG. 10 is a block diagram illustrating the inner configuration of the ECU in accordance with one embodiment of the present inventive concept.

As exemplarily shown in FIG. 10, the ECU 340 includes a controller 1010 and lower-level modules, such as a security key storage module 1020, a secret key decryption module 1030, a firmware decryption module 1040, an integrity check module 1050, a firmware installation module 1060, and an authentication module 1070.

The controller 1010 may control operation of the lower-level modules and control message input/output to the inside or outside of the ECU 340.

The ECU private key 404 and the server public key 403 are stored in the security key storage module 1020.

The secret key decryption module 1030 performs a function of extracting the server/ECU secret key 405 generated by the server 310 by decrypting the encrypted secret key (second data) using the ECU private key 404.

The firmware decryption module 1040 performs a function of extracting the original firmware by decrypting the encrypted firmware (first data) using the server/ECU secret key 405 extracted by the secret key decryption module 1030.

The integrity check module 1050 acquires a hash value (first hash value) by inputting the original firmware extracted by the firmware decryption module 1040 to a hash key generation function which is known in advance, and acquires a hash value (second hash value) generated by the server 310 by decrypting the decrypted hash value (third data) using the server public key 403. Thereafter, the integrity check module 1050 performs a function of checking integrity of the received firmware by judging whether or not the first hash value and the second hash value are the same. Here, a result of judgment may be transmitted to the controller 1010 through a designated control signal.

If the integrity check module 1050 judges that the received firmware is integral, the firmware installation module 1060 performs re-programming using the original firmware extracted by the firmware decryption module 1040 according to a control signal from the controller 1010.

If the integrity check module 1050 judges that the received firmware is defective, the controller 1010 may transmit a designated message indicating that re-programming is impossible to the diagnostic apparatus 320.

The authentication module 1070 performs a procedure of authenticating connection authority of the corresponding diagnostic apparatus 320 according to reception of a re-programming request message from the diagnostic apparatus 320. The authentication procedure performed by the authentication module 1070 has been described above with reference to FIG. 4.

The communication unit 1080 performs message or signal transmission/reception between the gateway 330 for vehicles and the corresponding ECU 340. For example, the communication unit 1080 may provide one of various bus communication units described above with reference to FIG. 2.

Although the above description states that the firmware encryption and decryption method in accordance with the present disclosure is applied to a server and an ECU for vehicles, the firmware encryption and decryption method may be applied to various electronic devices, which may perform firmware re-programming through interlocking with a server, for example, a smart-phone, a computer, various measuring instruments, an airplane, etc. Therefore, a subject receiving firmware data transmitted by the server, i.e., a reception terminal, may be not only an ECU for vehicles but also a specific module of the above various electronic devices or the corresponding electronic device.

As apparent from the above description, a firmware upgrade method and an apparatus and system thereof in accordance with the present disclosure have effects, as below.

First, the firmware upgrade method and the apparatus and system thereof in accordance with the present disclosure guarantee confidentiality and integrity and may thus perform safe firmware transmission and upgrade.

Second, the firmware upgrade method and the apparatus and system thereof in accordance with the present disclosure are highly resistant to hacking and may thus guarantee driver safety.

Third, the firmware upgrade method and the apparatus and system thereof in accordance with the present disclosure may be applied to various electronic devices as well as to upgrade of firmware of an electronic control unit for vehicles.

It will be apparent to those skilled in the art that various modifications and variations can be made in the present disclosure without departing from the spirit or scope of the disclosure. Thus, it is intended that the present disclosure covers the modifications and variations of this disclosure provided they come within the scope of the appended claims and their equivalents.

What is claimed is:

1. A firmware transmission method through which a server transmits firmware, comprising:
generating a secret key using a designated secret key generation function;
encrypting original firmware using the secret key;
encrypting the secret key using a public key of a reception terminal that is stored in advance; and
generating a hash value by inputting the original firmware to a designated hash function, and encrypting the generated hash value using a private key of the server that is stored in advance,
wherein firmware data includes the encrypted original firmware, the encrypted secret key, and the encrypted hash value is transmitted to the reception terminal.

2. The firmware transmission method according to claim 1, wherein the secret key is generated by inputting current time information to the secret key generation function.

3. The firmware transmission method according to claim 1, wherein the reception terminal is an electronic control unit (ECU) in a vehicle.

4. The firmware transmission method according to claim 3, wherein the firmware data further includes an ECU identifier to inherently identify the reception terminal.

5. The firmware transmission method according to claim 1, wherein the firmware data is transmitted to the reception terminal via a diagnostic apparatus and a gateway for vehicles.

6. A firmware data processing method through which an electronic control unit (ECU) for vehicles processes firmware data transmitted by a server, comprising:
receiving the firmware data including encrypted firmware, an encrypted secret key, and an encrypted hash value;
decrypting the encrypted secret key using a private key of the ECU, which is stored in advance;
decrypting the encrypted firmware using the decrypted secret key;
acquiring a first hash value by inputting the decrypted firmware to a designated hash function;
decrypting the encrypted hash value using a public key of the server which is stored in advance; and
determining whether or not the first hash value and the decrypted hash value are equal,
wherein, upon judging that the first hash value and the decrypted hash value are equal, designated re-programming is performed using the decrypted firmware.

7. The firmware data processing method according to claim 6, wherein the encrypted firmware is information acquired by encrypting the decrypted firmware using the decrypted secret key.

8. The firmware data processing method according to claim 6, wherein the encrypted secret key is information encrypted using a public key of the ECU.

9. The firmware data processing method according to claim 6, wherein the encrypted hash value is information encrypted using a private key of the server.

10. The firmware data processing method according to claim 6, wherein the decrypted secret key is generated by the server and is generated by inputting current time information as a seed value to a designated secret key generation function.

11. A system providing firmware upgrade comprising:
a diagnostic apparatus;
a server transmitting firmware data including encrypted firmware, an encrypted secret key, and an encrypted hash value to the diagnostic apparatus according to a firmware transmission request from the diagnostic apparatus; and
an electronic control unit (ECU), when the ECU receives the firmware data, decrypting the encrypted secret key using a private key of the ECU, decrypting the encrypted firmware using the decrypted secret key, and performing re-programming using the decrypted firmware if a first hash value acquired by inputting the decrypted firmware to a designated hash function and a second hash value acquired by decrypting the encrypted hash value using a public key of the server which is stored in advance are the same.

12. The system providing firmware upgrade of claim 11, wherein the server providing firmware comprises:
a controller;
a firmware database in which original firmware is stored;
a secret key generation module generating a secret key using a designated secret key generation function;
a firmware encryption module encrypting the original firmware using the secret key;
a secret key encryption module encrypting the secret key using a reception terminal public key which is stored in advance;
a hash value encryption module generating a hash value by inputting the original firmware to a designated hash function and encrypting the generated hash value using a private key of the server; and
a communication unit transmitting firmware data including the encrypted firmware, the encrypted secret key, and the encrypted hash value to an external device according to a control signal from the controller.

13. The server providing firmware of claim 12, further comprising:
a security key storage module for storing security keys maintained in the server, wherein the security key storage module is set such that only a user authenticated through a designated user authentication procedure can access the security key storage module.

14. The system providing firmware upgrade of claim 11, wherein the electronic control unit (ECU) which performs firmware upgrade by interlocking with the server, comprises:
a controller;
a communication unit receiving firmware data including encrypted firmware, an encrypted secret key, and an encrypted hash value and providing the received firmware data to the controller;
a secret key decryption module decrypting the encrypted secret key using a private key of the ECU, which is stored in advance;
a firmware decryption module decrypting the encrypted firmware using the decrypted secret key; and
an integrity check module acquiring a first hash value by inputting the decrypted firmware to a designated hash function, decrypting the encrypted hash value using a public key of the server which is stored in advance, and judging that the decrypted firmware is integral if the first hash value and the decrypted hash value are the same,
wherein, upon judging that the decrypted firmware is integral, re-programming is performed using the decrypted firmware.
